(19) United States
(12) Patent Application Publication
(10) Pub. No.: US 2018/0117490 A1
(43) Pub. Date: May 3, 2018

(54) INTERACTIVE PIÑATA WITH ELECTRONIC DEVICE

(71) Applicant: Rodolfo GARCIA TOLOSA, Ensenada (MX)

(72) Inventor: Rodolfo GARCIA TOLOSA, Ensenada (MX)

(21) Appl. No.: 15/427,828

(22) Filed: Feb. 8, 2017

(30) Foreign Application Priority Data
Nov. 3, 2016 (MX) MX/U/2016/000516

(51) Int. Cl. A63H 37/00; G06F 3/16; H04R 1/02; H04R 3/00; A63H 5/00

(52) U.S. Cl. CPC A63H 37/00; G06F 3/165; A63H 2200/00; H04R 3/00; A63H 5/00; H04R 1/028

(57) ABSTRACT

The present invention relates to the manufacturing industry in general, in particular relates to the production of piñatas with various materials, and more specifically relates to an interactive piñata with integrated electronic device formed by a piñata body adapted to receive an electronic device with an electronic card where a microprocessor and a vibration sensor is provided, said microprocessor is electronically connected to a loudspeaker with an on/off switch therebetween and is powered by a power supply; Said microprocessor may include a USB connection port and may be configured to read information from a USB memory in which a wide library of audio is stored which can be selected from music, voice, instructions or sounds of various kinds and which can be reproduced by programming the microprocessor at random or through a predetermined schedule to make parties and meetings more fun.

### CROSS-REFERENCE TO RELATED APPLICATIONS

This application claims priority to currently pending Mexican patent application MX/U/2016/000516 filed Nov. 3, 2016 entitled “PIÑATA INTERACTIVA CON DISPOSITIVO ELECTRÓNICO INTEGRADO, the contents of which are incorporated herein by reference in its entirety.

### BACKGROUND OF THE INVENTION

### Technical Field

The present disclosure generally pertains the manufacturing industry, and is more particularly directed towards production of piñatas.

### Related Art

The piñata is an old tradition in Mexican parties like birthdays, anniversaries, posadas (several gatherings before Christmas day), and other festivities. Its origin is the fusion between prehispanic cultures and Europeans. Today, the use of the piñatas in special events has a relevant place making the parties and gatherings more enjoyable, and an excuse to give away candies, fruits, toys and other articles, which brings joy to both kids and adults.

Piñatas come in different sizes, shapes, colors, and materials (such as clay, paperboard, and others). Presently, the body of the piñata has changed from clay to cardboard or newspaper harden by glue and other additives. This substitution of materials has allowed greater versatility of piñata designs, as well as new constructive processes through the use of profiles, molds or templates.

Mexican Pat. App. Pub. No. MX 2014008793 (Inventor: Arturo Hernandez Lopez) published on Jan. 21, 2016, shows a process of shaping the piñatas with paperboard by pressure using conventional machinery; under this process the materials get upgraded, recycling and avoiding imperfections that are generated through conventional methods in the piñata shaping.

Mexican Pat. App. Pub. No. MX JL04000002 (Inventor: Arnulfo Lopez Hernandez) published on Jun. 13, 2005 (ref. WO 03/018911), shows a process of shaping and materials of more quality due to the resistance and making the piñatas less dangerous in comparison with the ones made of clay. All of this makes them more appealing to the consumer specially the kids.

In all of the aforementioned cases, the novelty of such piñatas are related to a construction process, as well as improvements in the use of materials which, among other things, make the construction process easier, facilitate its use and placement in sales sites, and improve quality and appearance of the product that is best accepted by buyers. The case of the present invention, for its part, is not concerned with the piñata construction process or with attractive materials or designs. Rather, the present disclosure is directed toward overcoming known problems and/or problems discovered by the inventors.

### SUMMARY OF THE INVENTION

An interactive piñata is disclosed herein. The interactive piñata includes a piñata body having an internal face and an external face, and an electronic device affixable to at least one of the internal face and the external face of the piñata body. The electronic device includes a power supply configured to power the electronic device, a vibration sensor configured to sense an impact to the piñata body, and communicate an impact signal, a memory, and a loudspeaker. The electronic device also includes a processor configured to receive the impact signal from the vibration sensor, to communicate with the memory and select a sound from the memory, and to command the loudspeaker to emit said sound in response to receiving the impact signal.

In order to better understand the characteristics of the invention, the accompanying drawings are attached as an integral part of the drawings with an illustrative but non-limiting character, which are described below.

### BRIEF DESCRIPTION OF THE DRAWINGS

FIG. 1 shows a schematic diagram of a piñata body to which the electronic device has been incorporated, according to one embodiment of the present disclosure.

FIG. 2 shows a schematic diagram of the electronic device of FIG. 1, illustrating the electronic board with a microprocessor, a vibration sensor, a USB connection port (where a USB memory may be connected), and a wired connection of the switch to the loudspeaker.

FIG. 2a shows a schematic diagram of the electronic device of FIG. 1, illustrating a power supply and a wired connection of the switch to the loudspeaker, according to one embodiment of the present disclosure.

FIG. 3 shows a schematic of the electronic card of the electronic device of FIG. 1, according to one embodiment of the present disclosure.

### DETAILED DESCRIPTION

For a better understanding of the present disclosure, the follow detailed description of some of the embodiments thereof will be given, and shown in the appended drawings, which are for illustrative purposes, but are not limited to the following description. Accordingly, characteristic details of the interactive piñata with integrated electronic system are clearly shown in the following description and in the illustrative drawings which are attached, the same reference signs serving to indicate the same parts.

The present disclosure relates to a piñata having an interactive electronic device including a micro-processor card and a USB port connected to a vibration sensor and a speaker. Once the piñata gets hit, it can make sounds or expressions of pain, laughter, motivation/encouragement, challenge, as well as other predetermined phrases. Through the USB port one can also add music, instructions, or any type of audio. Some of these elements have been applied successfully in the oil industry, seismic alarms, among others, such as skill games or interactive dolls. Therefore, this interactive piñata has been developed in a way that is easy to build, functional, and economical. Moreover benefits may include production with a diversity of materials, specifically with an electronic device that makes this product more appealing, and giving family reunions, holidays and parties a more fun outcome.

Briefly described and generally, the interactive piñata with integrated electronic system includes a piñata body adapted to receive an electronic device including an electronic card with a microprocessor and a vibration sensor. Said microprocessor is configured to read information from a USB memory that can be connected via a USB port. The microprocessor may be connected electronically to a speaker and may include an associated on/off switch. The microprocessor may be powered by a power supply.

The body of the piñata can be built with different materials that can break easily while being hit by the player, such as cardboard, clay, plastic or other material, which in turn activates the vibration sensor and produces the desired sounds. Said piñata body is adapted to receive the electronic device that may be housed in a housing to be fixed to the inner face or the outer face of the piñata body.

The USB port is adapted to receive a USB memory in which a wide library of music audios, voice, instructions or sounds of various types are stored and can be reproduced by the microprocessor randomly or in order.

Said vibration sensor can be calibrated to measure different degrees of vibration intensity, and based on it, reproduce a certain audio. For example, in case of being hit hard, the device will say “ouch”, while if hit softer, it can challenge the player to intensify the blow.

When the vibration sensor detects a strong blow, the microprocessor can receive the signal and read an audio from the USB memory that manifests some sensation and that will be emitted through the loudspeaker that is the horn.

The audio library may include songs such as Christmas songs, piñata breaking songs (e.g., the famous “Dale, dale, dale” and “another round”/“otras rondas”). Likewise, the audio library may include voice instructions, festivities instruction, songs, voices of popular artists, voice commands/phrases, for example, of challenge, motivation, laughter, pain, etc.

As above, the electronic device may be embedded in a housing that is adapted to adhere to a part of the piñata body, for example, on its inner face or its outer face. In one preferred embodiments, the electronic device may be recoverable/reusable. That is to say when the piñata is destroyed said module can be recovered to be incorporated to another piñata body.

In a preferred embodiment, the speaker may be disposed on the outer face of the piñata (e.g., for the public to hear more clearly the emission of sounds, music or instructions).

The present disclosure has as an objective, to make available an interactive piñata with integrated electronic device that allows to emit sounds that stimulate the audience to continue playing. Another object is to allow this interactive piñata to be adapted to piñatas made in artisanal process or serial construction processes, no matter its shape, design, and materials. A further object is to enable said interactive piñata with integrated electronic device to better accommodate parties and gatherings for children and adults. Still another object is to make said electronic device recoverable after the celebration. A further aim of the disclosure is to make said interactive piñata without requiring high acquisition cost for its manufacture, assembly, and tooling, and all those qualities and objectives which will become apparent upon review of the present disclosure and drawings.

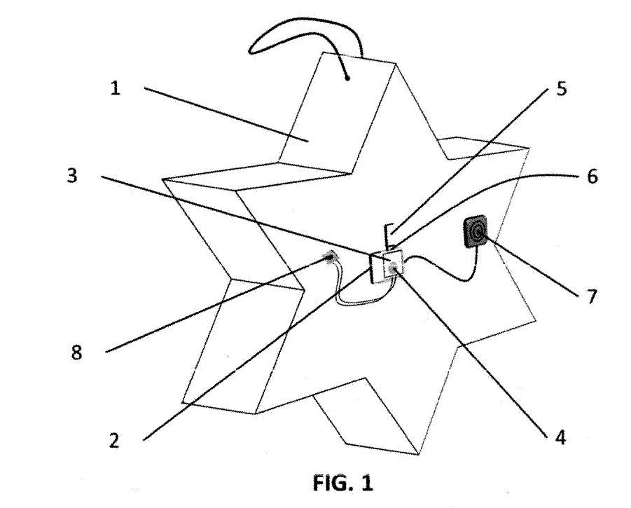

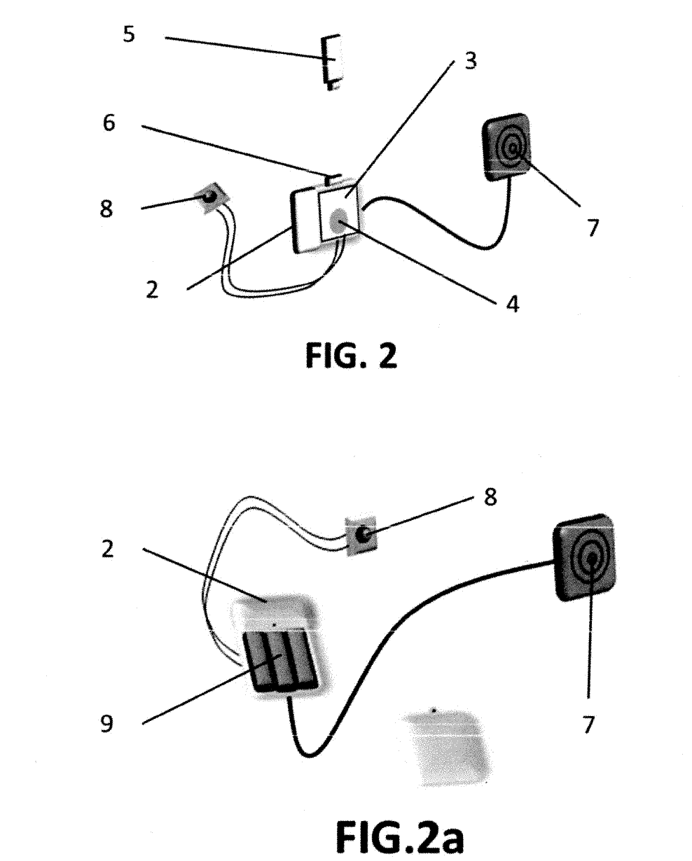

FIG. 1 shows a schematic diagram of an interactive piñata with integrated electronic system, according to one embodiment of the present disclosure. In particular, the interactive piñata with integrated electronic system may include a piñata body 1 adapted to receive an electronic device 2 including an electronic card 3 having at least one microprocessor (not shown) and a vibration sensor 4. The microprocessor may be configured to read information from a USB memory 5 connected via a USB connection port 6 connected to said microprocessor. The microprocessor may be further electronically connected to a speaker (loudspeaker 7), and include an on/off switch 8 therebetween. The microprocessor may be powered via a power supply 9. (FIG. 2a)

The piñata body 1 may be made of different materials such as cardboard, terra cota/earthenware, plastic or other materials that can break easily while being hit by the players (to activate the vibration sensor 4 and output a desired sound). The piñata body 1 may be adapted to receive the electronic device 2 which may be housed in a housing to be fixed to an inner face or an outer face of the piñata body 1.

FIG. 2 shows a schematic diagram of the electronic device 2, illustrating the electronic card 3 with its microprocessor (not shown), the vibration sensor 4, the USB connection port 6 (where the USB memory 5 is plugged in), the wired connection of the on-and-off switch 8, which goes to the loudspeaker 7. As shown, the USB connection port 6 is adapted to receive the USB memory 5, which may be full of a wide audio library. Further, music, voice, instructions or sounds of various kinds in the audio library may be selected and reproduced by microprocessor command (e.g., at random or by a predetermined program m ing).

The vibration sensor 4 may be calibrated to measure different degrees of vibration intensity, and based on it reproduce a certain audio. When the vibration sensor 4 detects a strong blow, the microprocessor may receive a signal, and instruct the reading of the USB memory 5 of an audio indicating a sensation that will then be output through the loudspeaker 7. For example, in the case of strong hit, the loudspeaker 7 may emit sounds like “ouch”, and in the case of weak hit, the loudspeaker 7 may challenge the player to hit harder.

The audio library may include holiday songs, piñata breaking songs (e.g., the famous “Dale, dale, dale”, “another round”, etc.), voice instructions, festivities instructions, songs, voices of popular artists, voice commands (e.g., of phrases of challenge, motivation, laughter, pain, etc.).

FIG. 2a shows a schematic diagram of the electronic device 2, illustrating the power supply 9, the wired connection of the on/off switch 8 to the loudspeaker 7, according to one embodiment of the present disclosure. As shown, in one preferred embodiment, the loudspeaker 7 may be disposed on the outer face of the piñata to more clearly hear its emitted sounds, music, or instructions. In addition, as already mentioned, between the microprocessor and the loudspeaker 7 there may be an on/off switch 8, for example, to beneficially avoid draining of the power supply 9 over time. Preferably the power supply 9 (e.g., rechargeable or non-rechargeable long life batteries) will be enclosed or otherwise secured with means to fix them in place.

As above, the electronic device 2 may be housed in an enclosure or other casing, which is adapted to adhere to a part of the piñata body 1 (e.g., on its inner face or its outer face). According to one embodiment, the electronic device 2 may be recoverable. For example, when the piñata body 1 is destroyed, the recoverable module (e.g., electronic device 2) may be recovered to be incorporated into another piñata body 1.

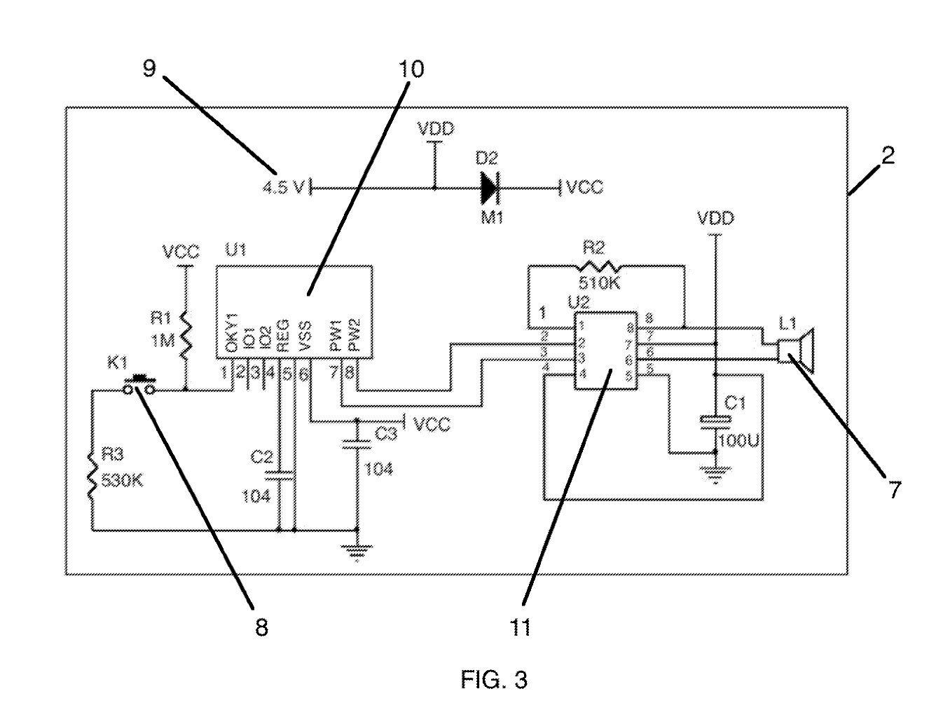

FIG. 3 shows a schematic of the electronic circuit of the electronic device 2 for interactive piñata with integrated electronic device, according to one embodiment of the present disclosure. As shown, the electronic device 2 may include at least microprocessor. For example, and as shown, the electronic device 2 may include an input microprocessor 10 and output microprocessor 11, Here, input microprocessor 10 may include a plurality of ports that are configured to receive information from by the vibration sensor 4. To illustrate, when the vibration sensor 5 detects a strong blow, the input microprocessor 10 may receive a signal and instruct the output microprocessor 11 to select from an audio library and play the music, voice, instructions or sounds of various kinds in response. These sounds may be played at random or by predetermined programming, and these played sounds may be output through the loudspeaker 7 to the general public. Further, when the on/off switch 8 is actuated (i.e., placed in the “off” position or “off” setting), the generated signal of the vibration sensor 4 may be turned off or otherwise interrupted from communicating to the input microprocessor 10. Thus, no warning is issued by the loudspeaker 7. Here, basic operating information of the power supply 9 is also shown.

The invention has been sufficiently described so that a person of ordinary skill in the art can reproduce and obtain the results mentioned in the present disclosure. However, any skilled person in the field of the art of the present disclosure may be able to make modifications not described in the present application. Notwithstanding, if these modifications require a structure or manufacturing process not described in the present disclosure, the modifications should be understood to be within the scope of the claimed subject matter. Having sufficiently described the invention, it is claimed as the property contained in the following claims.

1. An interactive piñata comprising:
a piñata body having an internal face and an external face; and
an electronic device affixable to at least one of the internal face and the external face of the piñata body, the electronic device including
a power supply configured to power the electronic device,
a vibration sensor configured to sense an impact to the piñata body, and communicate an impact signal,
a memory,
a loudspeaker,
a processor configured to receive the impact signal from the vibration sensor, to communicate with the memory and select a sound from the memory, and to command the loudspeaker to emit said sound in response to receiving the impact signal.

2. The interactive piñata of claim 1, further comprising a USB port configured to communicably couple with a USB memory; and
wherein the memory includes the USB memory, the USB memory having electronically stored the sound to be emitted by the loudspeaker; and
wherein the processor is further configured to select said sound to be emitted by the loudspeaker from the USB memory.

3. The interactive piñata of claim 2, wherein the USB memory includes a library of electronically stored sounds to be emitted by the loudspeaker; and
wherein the processor is further configured to select said sound to be emitted by the loudspeaker from the library of electronically stored sounds to be emitted by the loudspeaker.

4. The interactive piñata of claim 3, wherein the library of electronically stored sounds to be emitted by the loudspeaker include at least one of voice instructions, music and songs.

5. The interactive piñata of claim 3, wherein the processor is further configured to randomly select said sound to be emitted by the loudspeaker from the library of electronically stored sounds to be emitted by the loudspeaker.

6. The interactive piñata of claim 3, wherein the processor is further configured to select said sound to be emitted by the loudspeaker from the library of electronically stored sounds to be emitted by the loudspeaker in a predetermined order.

7. The interactive piñata of claim 1, wherein the power supply, the vibration sensor, USB port, the loudspeaker, and the power supply are electronically connected to and controlled by the processor.

8. The interactive piñata of claim 1, further comprising an on-and-off switch having an “on” setting and an “off” setting, the on-and-off switch configured to prevent activation of the loudspeaker when in its “off” setting.

9. The interactive piñata of claim 8, wherein the on-and-off switch is further configured to prevent the power supply from supplying power to the electronic device when in its “off” setting.

10. The interactive piñata of claim 1, wherein the processor includes at least one microprocessor.

11. The interactive piñata of claim 10, wherein the at least one microprocessor includes an input microprocessor and an output processor.

12. The interactive piñata of claim 11, further comprising:
an electronic card; and
a USB port coupled to the electronic card, the USB port configured to communicably couple with a USB memory; and
wherein the memory includes the USB memory, the USB memory having electronically stored the sound to be emitted by the loudspeaker;
wherein the input microprocessor is configured to select the sound to be emitted by the loudspeaker from the USB memory; and
wherein the input microprocessor, the output processor, and the vibration sensor are mounted to the electronic card, and the power supply is further configured to power the electronic card.

13. The interactive piñata of claim 1, wherein the electronic device is recoverable from the piñata body after use of the piñata body, and the electronic device is subsequently interchangeable for use with a plurality of piñata bodies.

14. The interactive piñata of claim 1, wherein the vibration sensor is further configured to measure different degrees of intensity of the impact to the piñata body; and
wherein the processor is further configured to select the sound from the memory in response to a measured degree of intensity of the impact to the piñata body.

15. The interactive piñata of claim 14, wherein the processor is further configured to select the sound from the memory in response to the measured degree of intensity of the impact to the piñata body corresponding to a strong impact or a weak impact, said strong impact having a greater degree of intensity than said weak impact.

16. The interactive piñata of claim 1, wherein a loudspeaker is affixed to the external face of the piñata body.

17. The interactive piñata of claim 1, wherein the piñata body is at least partially made of paperboard.

18. The interactive piñata of claim 1, wherein the piñata body is at least partially made of clay.

19. The interactive piñata of claim 1, wherein the piñata body is at least partially made of cardboard.

20. The interactive piñata of claim 1, wherein the piñata body is at least partially made of plastic.
